(19) United States
(12) Patent Application Publication
(10) Pub. No.: US 2012/0028203 A1
(43) Pub. Date: Feb. 2, 2012

(54) HIGH CAPACITY SHAFT KILN

(75) Inventor: Charles Robert Euston, Hamburg, PA (US)

(73) Assignee: FLSmidth A/S, Valby (DK)

(21) Appl. No.: 12/844,311

(22) Filed: Jul. 27, 2010

(51) Int. Cl. F27B 1/02; F27D 15/02; F27D 1/10

(52) U.S. Cl. 432/101; 432/133; 432/77

(57) ABSTRACT

A high capacity shaft kiln, which includes a plurality of vertical kiln shafts, a common heating unit and a cooling unit attached to the common heating unit. Each of the plurality of vertical kiln shafts are sized and configured to receive a source of material, which descends from an upper end thereof to a lower end thereof, and wherein each of the plurality of vertical kiln shafts has an inlet, which is sized and configured to receive a fuel source from a distribution device. The common heating unit is sized and configured to receive the source of material from the lower end of each of the plurality of vertical kiln shafts.

### FIELD OF INVENTION

The present invention relates to kilns useful for manufacturing cement and other allied products and, more particularly, to a high capacity shaft kiln having a plurality of vertical shaft kilns, which are parallel with one another.

### BACKGROUND OF THE INVENTION

Lime, or quicklime, is the oxide of calcium, CaO, and is commonly obtained by calcining limestone. Limestone is calcined in two main types of kilns, vertical or shaft kilns, and horizontal, rotary kilns. Lime is a very important basic material used in a variety of different industries. These include construction, agriculture, chemicals and several processing industries. There are two forms of lime: quicklime and hydrated lime. Quicklime is produced by heating rock or stone containing calcium carbonate (limestone, marble, chalk, geologically stratified seashells, etc.) to a temperature of around 1000° C. for several hours. In this process, known as “calcining” or simply “burning”, the carbon dioxide in the calcium carbonate is driven off leaving calcium oxide plus any impurities.

Quicklime can be hydrated, becoming more stable, and easier and safer to handle. Hydrated lime is produced by adding water to quicklime in a process called “hydration” or “slaking”, where the calcium oxide and water combine chemically to form calcium hydroxide.

During slaking the quicklime lumps will disintegrate to a fine powder. If high quality limes are required some form of screening and/or classification will be required at this stage to grade the lime. Hydrated lime is normally supplied and sold in bagged form.

If quicklime is hydrated with a large amount of water and well agitated, it forms a milky suspension known as milk of lime. Allowing the solids to settle and drawing off the excess water forms a paste-like residue known as lime putty. Methods of burning lime range from traditional and simple to highly sophisticated and automated. The traditional methods are labor-intensive and energy inefficient, and tend to produce unevenly burned lime, with a proportion that is underburnt and/or overburnt, while the highly sophisticated and automated methods produce lime of a very consistent quality.

One type of method used for producing lime and other related products is with vertical shaft kilns or shaft kilns. The raw material is fed in at the top of the kiln and the product is withdrawn from the bottom, causing the material to move slowly downwards through the kiln. Heat to calcine the material is introduced roughly in the middle of the kiln and therefore any material above is preheated by rising hot exhaust gases, and any material below the middle of the kiln is cooled by incoming air. In this way, material entering the kiln at the top is first preheated, then calcined and finally cooled during its passage through the kiln.

Currently, shaft kilns are limited in capacity to approximately 600 metric tons per day (MTPD). This limitation arises from maldistibution of gas and material in a single shaft. Specifically, as the capacity of the shaft kiln increases the active cross section must increase proportionally. However, at approximately 600 metric tons per day (MTPD), the cross section is so large that the gases cannot be evenly distributed across the bed of the shaft kiln and material flow is not plug flow.

Accordingly, it would be desirable to overcome these limitations by using multiple shafts in the same unit, wherein each shaft has a material feeding device and gas flow regulating device, such that the stone flow and gas distribution can be regulated to suit each shaft kiln.

### SUMMARY OF THE INVENTION

In accordance with an exemplary embodiment, a high capacity shaft kiln comprises: a plurality of vertical kiln shafts, which are sized and configured to receive a source of material, which descends from an upper end thereof to a lower end thereof, and wherein each of the plurality of vertical kiln shafts has an inlet, which is sized and configured to receive a fuel source from a distribution device; a common heating unit which is sized and configured to receive the source of material from the lower end of each of the plurality of vertical kiln shafts; and a cooling unit attached to the common heating unit.

In accordance with another exemplary embodiment, a high capacity shaft kiln comprises: a plurality of parallel vertical kiln shafts, which are sized and configured to receive a source of material, which descends from an upper end thereof to a lower end thereof, and wherein each of the plurality of vertical kiln shafts has an inlet, which is sized and configured to receive a fuel source from a distribution device and an exhaust duct; a common heating unit which is sized and configured to receive the source of material from the lower end of each of the plurality of vertical kiln shafts; and a cooling unit attached to the common heating unit.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of shaft kilns, and methods of making such devices are shown in the accompanying drawings in which:

FIG. 1 is a perspective view of a high capacity shaft kiln in accordance with an exemplary embodiment.

### DETAILED DESCRIPTION OF PRESENT PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

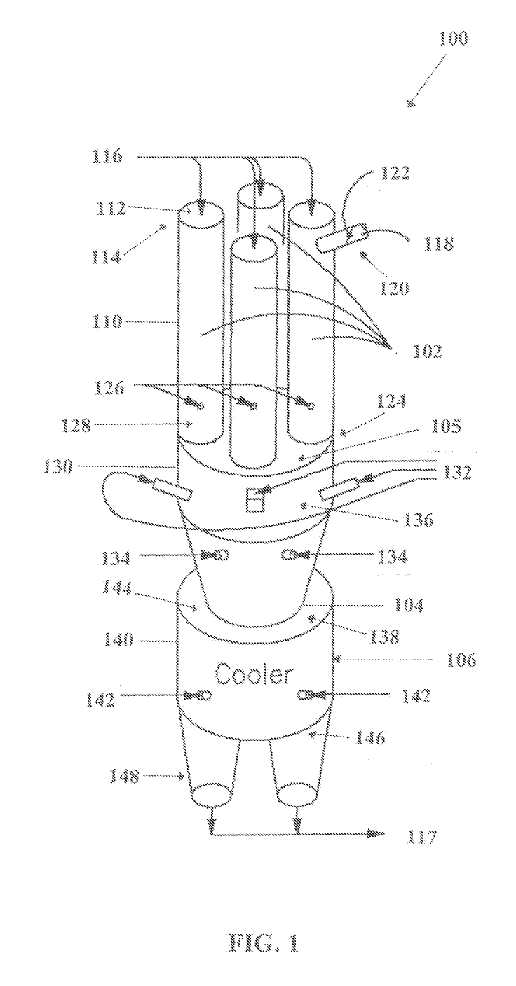

FIG. 1 is a perspective view of a high capacity shaft kiln 100 in accordance with an exemplary embodiment. As shown in FIG. 1, the high capacity shaft kiln (or annular shaft kiln) 100 include a plurality of vertical shafts (or kiln shafts) 102, a common firing unit 104 upon which the plurality of vertical kiln shafts 102 are attached thereto, and a cooling unit 106.

In accordance with an exemplary embodiment, the high capacity vertical shaft kiln 100 as described herein can be used for the burning of limestone, dolomite, magnesite, cement, and ores or the like. In use, hot gases calcine or burn a source of material 116 (i.e., limestone). As the source of material 116 (i.e., limestone) descends from the vertical shafts 102, the source of material 116 enters a calcining zone, which is formed by the common firing area 104. The burned material is then permitted to descend through the calcining zone to the cooling unit (or cooler) 106 wherein cooling air is permitted to enter the kiln 100, so as to cool the burned material 116 as it descends through the cooling unit (or cooler) 106.

Each of the plurality of vertical shafts (or kiln shafts) 102 includes a vertical conduit (or column) 110 having an inlet 112 at an upper end 114 wherein a source of material 116 such as limestone, cement, ores and other materials are fed. An exhaust (or offgas) duct 118 is located on an upper portion 120 of each of the vertical conduits 110, which removes the hot gases (or fuel) from the vertical conduit. Each of the exhaust (or offgas) ducts 118 includes a damper 122, which controls the airflow (and release of heat and/or gases) for each of the vertical conduits 110. It can be appreciated that the exhaust (or offgas) duct 118 in addition to removing or providing an outlet for spent combustion gas, the exhaust (or offgas) duct 118 can also provide a conduit for fresh air to go down the exhaust (or offgas) duct 118 and corresponding vertical conduit (or column) 110 to generate preheated combustion air. In accordance with another exemplary embodiment, the hot gases from the exhaust (or offgas) duct 118 can be recycled to form a preheated burner air source (not shown).

Each of the vertical conduits 110 also include a distribution device or gas flow regulating device (not shown) which feeds a gas or fuel source 126 to the vertical conduit 110 through a gas or fuel inlet 128 located on a lower portion of the vertical kiln shaft 102. In accordance with an exemplary embodiment, the gas or fuel source 126 is preferably oil, coal, wood and/or other suitable material. The gas or fuel inlet 128 is preferably located approximately ⅔ to ¾ down the vertical conduit 110. In accordance with an exemplary embodiment, the shaft kiln 100 preferably has at least two (2) vertical kiln shafts 102, and more preferably at least three (3), and most preferably at least four (4) or more vertical kiln shafts 102. However, it can be appreciated that any number of vertical kiln shafts 102 can be used to obtain a desired capacity for the high capacity shaft kiln 100. In addition, each of the vertical kiln shafts 102 is preferably in parallel with one another.

Each of the plurality of vertical kiln shafts 102 are attached to and/or mounted to a common firing unit (or common firing portion) 104. The common firing unit 104 includes an upper plate (or member) 105, which is attached to a lower end 124 of the vertical conduit 110, and housing 130 with one or more feeders 132 to control the flow rate of the source of material (or solids) on an upper portion thereof, and one or more gas or fuel inlets 134 located on a lower portion thereof. It can be appreciated that the one or more feeders 132, which control the flow rate of the source of material 116 is an optional element. The one or more gas or fuel inlets 134 of the common firing unit 104 are preferably equally spaced around the upper portion thereof. In accordance with an exemplary embodiment, the housing 130 has annular upper section 136 and a conical (or tapered) lower section 138. In accordance with an exemplary embodiment, the conical lower section 138 has a greater outer diameter adjacent to the annular upper section 136 and tapers downward to the cooling unit 106.

In accordance with exemplary embodiment, the cooling unit 106 consists of an annular housing 140 having a plurality of air inlets 142 on a lower portion thereof. The air inlets 142 are preferably equally spaced around the annular housing 140, an upper plate (or member) 144, and a lower plate (or member) 146. Attached to the lower plate 146 is one or more conical shaped outlets 148, which deliver the treated source of material 116 (i.e., produced product 117) to a hopper or other storage system (not shown).

In accordance with an exemplary embodiment, each of the vertical conduits 110 are preferably approximately 4 to 10 meters in length depending on material 116 size, and having an inner diameter (ID) of approximately 2 to 4 meters, which also depends on material 116 size. In accordance with an exemplary embodiment, the vertical conduits 110 are steel shafts lined with a refractory material, such as alumina, magnesia or fireclay bricks.

The source of material 116 is preferably limestone or other mineral aggregate such as chalk and/or marble containing in excess of 90% calcium carbonate is charged (and/or placed) into an upper end 114 of each of the plurality of vertical kiln shafts 102 from a hopper or other source of material using a material feeding device (not shown) by way of inlets, and the limestone is calcined as the limestone descends slowly to a bottom portion of the kiln 100 where the limestone (or produced product 117) is discharged into a collection hopper via outlets within the cooling unit 106 from which it may be collected and transferred to a storage silo or other storage unit (not shown).

In accordance with an exemplary embodiment, the source of material 116 is preferably a limestone supply having a minimum of 97% calcium carbonate and has been processed to be clear and free of matter such as clay and/or dust. In addition, it is preferable that the source of material 116 has a minimum dimension of about 1 inch and a maximum dimension of about 6 inches, with a preferred dimension of about 2 inches by 4 inches. In accordance with an exemplary embodiment, the source of material 116 is preferably stored in a hopper having a material feeding device (not shown), which includes suitable metering and distribution mechanisms for controlling the feed of the source of material 116 into each of the plurality of kiln shafts 102.

In operation, a source of material 116 is fed into the inlet 112 at the upper end 114 of each of the kiln shafts 102, and the produced product 117 is withdrawn from the bottom of the high capacity shaft kiln 100, causing the material to move slowly downwards through the plurality of kiln shafts 102, the common heating unit 104, and the cooling unit 106. Heat to calcine the material is introduced roughly in the middle of the plurality of kiln shafts 102 and a second heating zone is located within the common heating unit 104. Therefore, any source of material 116 above the heating zones is preheated by rising hot exhaust gases, and any source of material 116 below the heating zones is cooled by incoming air. The source of material 116 entering the plurality of kiln shafts 102 at the upper end 114 is first preheated, then calcined and finally cooled during its passage through the cooling unit 106 of the kiln 100.

In accordance with an exemplary embodiment, by incorporating a plurality of kiln shafts 102 on single unit or kiln 100, the capacity of the kiln 100 can be drastically increased above the approximately 600 metric tons per day (MTPD) that can be achieved with the current shaft kilns. For example, by incorporating a plurality of kiln shafts 102, an increase in production of at least 2 to 5 times current capacity can be obtained within a single kiln 100.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

What is claimed is:

1. A high capacity shaft kiln comprising:
a plurality of vertical kiln shafts, which are sized and configured to receive a source of material, which descends from an upper end thereof to a lower end thereof, and wherein each of the plurality of vertical kiln shafts has an inlet, which is sized and configured to receive a fuel source from a distribution device;
a common heating unit which is sized and configured to receive the source of material from the lower end of each of the plurality of vertical kiln shafts; and
a cooling unit attached to the common heating unit.

2. The kiln of claim 1, wherein each of the plurality of vertical kiln shafts consist of a vertical conduit having an inlet on the upper end and an outlet on the lower end.

3. The kiln of claim 1, further comprising an exhaust duct on an upper portion of each of the vertical kiln shafts.

4. The kiln of claim 3, further comprising a damper within each of the exhaust ducts, and wherein the damper is sized and configured to control an airflow within the vertical kiln shaft.

5. The kiln of claim 1, wherein each of the plurality of kiln shafts has a material feeding device associated therewith, which is sized and configured to feed the source of material to the upper end of the vertical shaft kiln.

6. The kiln of claim 1, wherein the plurality of vertical kiln shafts are parallel to one another.

7. The kiln of claim 1, wherein the common heating area has one or more gas distribution devices for distribution of a fuel source to the common heating area.

8. The kiln of claim 1, wherein the common heating area further includes a feeder area having a plurality of feeders, which are sized and configured to control the flowrate of the source of material within the kiln.

9. The kiln of claim 1, wherein the cooling unit has one or more air inlets.

10. The kiln of claim 1, wherein the kiln shafts are steel shafts lined with a refractory material, such as alumina, magnesia and/or fireclay bricks.

11. The kiln of claim 1, wherein the source of material is placed into the upper end of each of the plurality of vertical kiln shafts from a supply hopper and is discharged from the cooling unit into a collection hopper.

12. The kiln of claim 1, further comprising a material feeding device which is sized and configured to control a feed of the source of material into each of the plurality of vertical kiln shafts.

13. The kiln of claim 12, wherein the material feeding device includes a metering and distribution mechanism, which is sized and configured to control the feed of the source of material into each of the plurality of kiln shafts.

14. The kiln of claim 1, wherein the cooling unit has at least one outlet, which is sized and configured to disperse the source of material from the high capacity shaft kiln into a storage hopper.

15. A high capacity shaft kiln comprising:
a plurality of parallel vertical kiln shafts, which are sized and configured to receive a source of material, which descends from an upper end thereof to a lower end thereof, and wherein each of the plurality of vertical kiln shafts has an inlet, which is sized and configured to receive a fuel source from a distribution device and an exhaust duct;
a common heating unit which is sized and configured to receive the source of material from the lower end of each of the plurality of vertical kiln shafts; and
a cooling unit attached to the common heating unit.

16. The kiln of claim 15, wherein each of the plurality of vertical kiln shafts consist of a vertical conduit having an inlet on the upper end and an outlet on the lower end.

17. The kiln of claim 16, further comprising a damper within each of the exhaust ducts, and wherein the damper is sized and configured to control an airflow within the vertical kiln shaft.

18. The kiln of claim 15, wherein each of the plurality of kiln shafts has a material feeding device associated therewith, which is sized and configured to feed the source of material to the upper end of the vertical shaft kiln.

19. The kiln of claim 15, wherein the common heating area has one or more gas distribution devices for distribution of a fuel source to the common heating area, and a feeder area having a plurality of feeders, which is sized and configured to control the flowrate of the source of material within the kiln.

20. The kiln of claim 15, wherein the cooling unit has one or more air inlets.

21. The kiln of claim 15, further comprising a material feeding device which is sized and configured to control a feed of the source of material into each of the plurality of vertical kiln shafts, and includes a metering and distribution mechanism which is sized and configured to control the feed of the source of material into each of the plurality of kiln shafts.
